(19) United States
(12) Patent Application Publication
(10) Pub. No.: US 2026/0038789 A1
(43) Pub. Date: Feb. 5, 2026

(54) METHOD AND DEVICE FOR ANALYSING SAMPLE MATERIAL

(71) Applicant: Bruker Daltonics GmbH & Co. KG, Bremen (DE)

(72) Inventors: Sebastian BÖHM, Bremen (DE); Andreas HAASE, Bremen (DE); Jens BOßMEYER, Bremen (DE)

(21) Appl. No.: 19/284,102

(22) Filed: Jul. 29, 2025

(30) Foreign Application Priority Data
Aug. 2, 2024 (DE) 102024122185.2

(51) Int. Cl. H01J 49/40; H01J 49/00

(52) U.S. Cl. CPC H01J 49/401; H01J 49/0095

(57) ABSTRACT

The invention relates to methods and devices for analysing sample material on a sample carrier, comprising an operating mode as follows: providing a time-of-flight mass analyser with an ion generating unit having a mount for the sample carrier, an ion receiver, a flight route between them determining the longest time-of-flight, an ion selector along the route, and a clock generator for repeatedly triggering an ion generating pulse at the sample carrier and a subsequent pulse for accelerating ion species onto the flight route; defining one or more ranges of mass-to-charge ratios (m/z), each with an upper limit corresponding to a time-of-flight shorter than the longest time-of-flight; selecting a cycling of ion generating pulses such that the duration between successive pulses is shorter than the longest time-of-flight but longer than the acceleration time; and analysing the sample material using the mass analyser, the selected pulse cycling, and the ion selector.

### BACKGROUND OF THE INVENTION

### Field of the Invention

The invention relates to methods and devices for analysing sample material, for example, flatly extending tissue sections, in particular in imaging mass analysis.

### Description of the Related Art

The prior art will be explained hereinafter with reference to a special aspect. However, this is not to be understood as a restriction. Useful refinements and changes of what is known from the prior art can also be applicable beyond the comparatively narrow framework of this introduction and will readily result for those skilled in the art in this area after reading the following disclosure.

Axial time-of-flight mass analysis (time of flight, TOF) using matrix-assisted laser desorption and ionization (MALDI) is a proven method for examining the molecular content of laterally extending sample material, such as tissue sections, in the context of mass spectrometry imaging (MSI). Roughly three phases can be defined which determine the time required for such examinations: (i) the sample preparation, which in particular includes providing the tissue and applying the matrix substance to a tissue section from which the tissue is taken, (ii) the planar scanning of the tissue section in order to capture the molecular information therein in a location-resolved manner, and (iii) the data evaluation, which typically has the goal of creating distribution maps of selected molecules of interest over the tissue section from the time-of-flight transients captured in a location-resolved manner.

Data acquisition methods which have heretofore been used in axial time-of-flight mass analysis utilize the possibility provided by time-of-flight mass analysis to simultaneously measure ion species having mass to charge ratios m/z deviating strongly from one another and therefore times-of-flight deviating strongly from one another by capturing in a single time-of-flight transient. In particular in very flatly extended sample material such as a tissue section, this has the result, in particular if a high spatial resolution is desired, that phase (ii) can last several hours or even a few days, and therefore has a tendency to occupy a very long time, if not even most of the time of the three phases. This can result in situations in which the time necessary to scan the sample material in phase (ii) using the mass analyser is disproportionate to the increased informational value of the molecular content extracted from the sample material, for example, if the ion signals of specific ion species of interest for the examination do not span or populate the entire detectable mass range, but rather are only located at selected points or in one or multiple comparatively narrow partial ranges thereof.

Documents of the prior art are briefly listed hereinafter, which—without claim to completeness—can contribute to understanding the present disclosure:

U.S. Pat. No. 5,396,065 A describes a method and a device for analysing ions by determining times-of-flight, which include the preparation of a coded sequence for the start of ion packets from a source area in the direction of a detector. The coded sequence is one in which the high-mass ions of a front packet are overtaken by the low-mass ions of a rear packet. In this way, a high-efficiency time-of-flight mass spectrometer is to result. Action is taken on the ions of each packet in order to bundle them, by which the initial spatial and/or velocity distributions of the ions are equalized upon the start of the packet. The arrival times of the ions are determined at the detector to obtain a signal having overlapping spectra which correspond to the packets started in an overlapping manner. A correlation between the overlapping spectra and the coded start sequence is used to obtain a single, nonoverlapping spectrum.

The work of M. Guilhaus et al. (Rapid Communications in Mass Spectrometry, Vol. 11, 951-962 (1997)) is an earlier overview article on the theme of time-of-flight mass analysis.

Patent publication DE 102 47 895 A1 (corresponding to US 2004/0164239 A1 and GB 2 396 957 A) relates to a time-of-flight mass spectrometer having orthogonal injection of an ion beam into a rapid pulser, which pulses the ions of the ion beam for an accurate mass determination into the drift section of the spectrometer. Increasing the utility of the ions by a high pulser frequency, carrying out the data recording cyclically at equal frequency, and assigning slow ions, which are only measured in one of the following cycles, to the correct starting pulse by way of the shape of the lines or line patterns are disclosed.

Patent publication WO 2011/135477 A1 generally relates to the area of mass-spectroscopy analysis and in particular relates to the improvement of the sensitivity, velocity, and the dynamic range in electrostatic mass spectrometers including open electrostatic traps or time-of-flight mass spectrometers having extended flightpath.

Patent publication DE 10 2009 013 653 A1 (corresponding to US 2010/0237238 A1 and GB 2 468 747 A) relates to the rapid and cost-effective analysis of amino acid sequences of proteins using mass spectrometers, which use matrix-assisted laser desorption and ionization (MALDI).

Patent publication DE 11 2015 003 808 T5 (corresponding to WO 2016/027085 A1) describes a mass spectrometer, comprising a time-of-flight mass analyser, which comprises an acceleration electrode, a time-of-flight region, and an ion detector, and a control system, which is designed and formed so that it (i) applies a plurality of extraction pulses to the acceleration electrode, to accelerate successive ion groups in the time-of-flight region, wherein ions having a relatively high mass to charge ratio in a preceding ion group arrive at the detector after ions having a relatively low mass to charge ratio in a following ion group, wherein ions within each successive ion group have a mass to charge ratio within one or multiple predetermined, selected, or otherwise known mass to charge ratio ranges; and (ii) ascertains a frequency or a period of time of the plurality of extraction pulses, which avoids ions from the successive ion groups from coinciding at the ion detector, wherein the plurality of extraction pulses is applied in the ascertained frequency or in the ascertained period of time.

In the article by Mark J. Lim et al. “MALDI HiPLEX-IHC: multiomic and multimodal imaging of targeted intact proteins in tissues,” Front. Chem. 11:1182404 (2023) (doi: 10.3389/fchem.2023.1182404), an approach is described which is known as matrix-assisted laser-desorption/ionization high-plex immunohistochemistry (MALDI HiPLEX-IHC or MALDI-IHC for short) and is based on the development of novel photo-cleavable mass tags (PC-MTs) from AmberGen, Inc. (Billerica, Massachussetts, US).

In view of the preceding statements, there is a demand for improving methods and devices of (axial) time-of-flight mass analysis and making it higher performance, in particular faster. Further objects to be achieved by the invention readily result for a person skilled in the art upon reading the following disclosure.

### SUMMARY OF THE INVENTION

According to a first aspect, the disclosure relates to a method for analysing sample material, which is applied to a sample carrier, comprising:—providing an (axial) time-of-flight mass analyser, which comprises an ion generating unit having a mount for the sample carrier, an ion receiver, a flight route between ion generating unit and ion receiver, which co-determines the longest time-of-flight, an ion selector along the flight route, and a clock generator for the repeated triggering of an ion generating pulse locally at the sample carrier and a subsequent pulse for accelerating ion species directly out of the ion generating unit onto the flight route, —defining one or multiple ranges of mass to charge ratios m/z each having an m/z upper limit, corresponding to a time-of-flight which is shorter than the longest time-of-flight, —selecting a cycling of ion generating pulses such that a duration between two successive ion generating pulses is shorter than the longest time-of-flight and is longer than an acceleration time of ion species out of the ion generating unit, —analysing the sample material using the (axial) time-of-flight mass analyser and the selected cycling of ion generating pulses, wherein the ion selector is operated so that at first fly through times, which correspond to one or multiple mass to charge ratios within the one or multiple defined ranges, it lets ion species pass to the ion receiver and at second fly through times, which correspond to one or multiple mass to charge ratios outside the one or multiple defined ranges, it prevents ion species from reaching the ion receiver, —recording one or multiple time-of-flight transients at the ion receiver, which contains or contain ion signals of ion species from the one or multiple defined ranges, and—assigning mass to charge ratios to the ion signals.

The inventors have recognized that a time-of-flight mass analysis having many successive pulsed ion generating events can be accelerated in particular in that a restricted number of ranges of mass to charge ratios, which contain molecules of interest, which permit a statement about the occurrence, frequency, and/or distribution of these molecules on the sample material, are defined from one or multiple ranges of mass to charge ratios, which corresponds or correspond not to the entire m/z range that can be examined using the time-of-flight mass analyser in a single transient detected via the longest time-of-flight, but rather only comprises specific points thereof or corresponds to one or multiple partial ranges thereof, and at the same time increases the cycle rate of the pulsed ion generation in relation to an approach according to which one waits until all ion species generated using a pulse have reached the ion receiver from the ion generating unit (pulse and wait, with respect to the longest time-of-flight).

In some embodiments, ion species having a low mass to charge ratio of a subsequent sequence made up of ion generating pulse and acceleration pulse can catch up to or even overtake ion species having a higher mass to charge ratio of a prior sequence made up of ion generating pulse and acceleration pulse on the flight. Ion signals are detected in m/z ranges using such a procedure, which can overlap although they originate from different sequences of ion generating pulse and acceleration pulse, so that assigning them to a pulse sequence and therefore substantiating a unique time-of-flight and determining the mass to charge ratio can be challenging, but with suitable selection of the operating variables of the time-of-flight mass analyser, the ion species of the molecules of interest can be detected without overlap and permit the assignment of mass to charge ratios.

If the range or ranges of mass to charge ratios is or are defined so that the m/z upper limit and possibly an m/z lower limit are each spaced apart sufficiently far from the objectively largest or smallest detectable mass to charge ratios, which can be verified using a specific embodiment of a time-of-flight mass analyser, the ion selector can be used to reduce the ion current on the flight route from the ion generating unit to the ion receiver in that it is switched to blocking after a sequence made up of ion generating pulse and acceleration pulse until the ion species of interest, which corresponds, for example, to an m/z lower limit having the lowest mass to charge ratio, which thus reacts fastest to the acceleration pulse, prepares to pass the ion selector at a first fly through time. The ion selector can also be switched to blocking if the ion species of interest, which corresponds to an m/z upper limit having the greatest mass to charge ratio, which thus reacts slowest to the acceleration pulse, has passed the ion selector at a second fly through time. It is possible to open the ion selector for a time window which enables the respective lightest up to the respective heaviest ion species of interest from a defined range to fly through, but otherwise to switch it to blocking. Alternatively, it is possible to switch the ion selector for the ion current resulting from a sequence of ion generating pulse and acceleration pulse multiple times to blocking and transmitting, if the time-of-flight intervals between the various defined ranges of mass to charge ratios at the location of the ion selector permit it. Furthermore, it is possible to block the ion selector for a time span which lies between the time of triggering an acceleration pulse and the fly through time of an ion species of interest accelerated by the pulse by the ion selector, which has a mass to charge ratio which corresponds to the m/z lower limit of the or a defined range.

If the times-of-flight of various defined ranges should differ from one another so strongly that multiple switching of the ion selector is possible without influencing the potential conditions along the flight route for the ion species of interest from these defined m/z ranges, it is also possible to switch to blocking in a period of time between the fly through of two ion species, one of which has a mass to charge ratio which corresponds to an m/z upper limit of a first defined range, and the other of which has a mass to charge ratio which corresponds to an m/z lower limit of a second defined range. Switching times of typical ion selectors can be approximately 15-20 ns. The blocking and, connected thereto, the filtering out and discarding of ion species which do not promise any increased informational value, reduce any background in the time-of-flight transients, which facilitates the data evaluation, and also reduce the load of the ion receiver, which has to perform less signal conversion than without use of an ion selector.

Depending on the experimental location and alignment, ion species of a MALDI matrix substance can be viewed as an example of those without increased informational value, which are also to be encountered more frequently in cluster form regularly at mass to charge ratios up to m/z˜800. Whereas MALDI matrix substance ions can actually always be viewed as background, the classification of an ion class as background can also depend on the objectives of an experiment. If an experiment is directed, for example, to proteins, the average molecular weights of which are in the range between 10,000 and 100,000 atomic mass units, the substance class of the lipids, the average molecular weights of which are in the range between 200 and 800 atomic mass units, can be viewed as background which is preferably to be filtered out.

The ion selector can be arranged along the flight route adjacent to the ion generating unit. Measures are preferably taken which prevent the switching voltages of the ion selector from cross talking to the ion generating unit, for example, by selecting a sufficient distance or by using suitable shielding electrodes.

An axial time-of-flight mass analyser is in particular characterized in that ion species are essentially accelerated along their existing movement direction onto the flight route, in other words using substantially parallel acceleration. Axial time-of-flight mass analysers are to be distinguished in particular from mass analysers having orthogonal acceleration, where ion generation and acceleration of ion species onto the flight route take place in spatially separated assemblies and ion species are accelerated substantially perpendicular to a prior movement direction onto the flight route (orthogonal acceleration time-of-flight, oaTOF or simply OTOF). In particular axial MALDI-TOF structures are known, in which sample material is ablated from a sample carrier in a pulsed manner, ionized, and accelerated substantially parallel to a surface normal of the sample carrier onto the flight route.

The longest time-of-flight of an axial time-of-flight mass analyser is the time span which a selected heavy ionized molecule of specific mass or a specific mass to charge ratio m/z requires to cover the flight route from the ion generating unit to the ion receiver, and is dependent on the length of the flight route and on the amplitude of the acceleration pulse and on any components guiding or forming the ion beam along the flight route, which influence, for example, the velocity of an ion species in flight. In conventional axial time-of-flight mass analysers, the longest time-of-flight, for example, if a single reflector-turned flight route is used, can be about 100 μs, which depending on the instrumental set up can correspond to a mass to charge ratio of m/z 5000. At a valency of the ion species of c=1, as prevails, for example, in the case of MALDI, the upper limit of the mass to charge ratio also corresponds to the mass upper limit of approximately 5000 atomic mass units.

The sample carrier can comprise a plate made of stainless steel or another electrically conductive plate. For MALDI applications in transmitted light or transmission MALDI, the sample carrier can be transmissive for electromagnetic waves, for example, in the form of an indium tin oxide-coated object carrier (indium tin oxide, ITO). The sample carrier can have the dimensions of a standard micro titration plate: length 127.76 mm, width 85.48 mm, height 14.35 mm.

The time span between an ion generating pulse and a following acceleration pulse can be selected according to the known methods of delayed extraction or pulsed ion extraction, which are known to a person skilled in the art and do not require further explanation. Reference is made by way of example and without claim of completeness to the study by M. L. Vestal et al. (Rapid Communications In Mass Spectrometry, Vol. 9, 1044-1050 (1995)) and patent specification DE 196 38 577 C1 (corresponding to U.S. Pat. No. 5,969,348 A), to which reference is hereby expressly made by citation.

The acceleration time characterizes the point in time from which a further sequence of ion generating pulse and acceleration pulse can be applied to the sample material without influencing the flight or the time-of-flight of ion species which were created by a prior sequence of ion generating pulse and acceleration pulse, in the ion generating unit or on their path through the flight tube. It can be determined in particular by the m/z upper limit of a defined range having the greatest mass to charge ratio, since an ion species, the mass to charge ratio of which corresponds to this upper limit, requires the longest to depart the ion generating unit and therefore the area of influence of ion generating pulse and acceleration pulse. In a conventional axial time-of-flight mass analyser, the acceleration time for the greatest still detectable mass (m/z˜5000), to which the longest time-of-flight can be assigned, can be approximately 3.5 μs and can decrease accordingly for the heaviest ion species, which still corresponds to one of the defined ranges, according to the m/z interval or time-of-flight interval from the greatest generally detectable mass.

The mass resolution capacity m/Δm of the axial time-of-flight mass analyser is preferably 1000 or more, more preferably 10,000 or more, still more preferably 20,000 or more, ideally 50,000 or more. It preferably extends up to 300,000.

The flight route of the axial time-of-flight mass analyser ends at the ion receiver and is typically designed so that it is substantially free of electrical potentials, with the exception, for example, of reflector structures or structures having a laterally-focusing single lens. The ion receiver can be an assembly which operates using the principle of secondary electron multiplication. In particular, the ion receiver can comprise a multichannel plate (or also microchannel plate), for example, in a chevron arrangement, or an array of dynodes. Conversions of secondary electrons into photons and back into secondary electrons are also possible in the course of the secondary electron multiplication, for example, to be able to decouple the signal via a light-transmissive window out of a negative pressure area of the ion receiver. The incoming ion current at the ion receiver can be registered in one or multiple time-of-flight transients. Such a spectral data set can comprise a frequency distribution of detected ion species depending on a mass parameter m or mass-related parameters such as the time-of-flight before the conversion or also the mass to charge ratio m/z. Such a spectral data set can be a spectrum; after corresponding postprocessing, however, it can also comprise a list about pervasive noise or background of detected signals (peak list). Depending on the analysis structure, such a spectral data set can contain specifications in the metadata about the circumstances of the data acquisition, for example, the setting used for the waiting time between ion generating pulse and acceleration pulse, the amplitude (possibly changing over time) of the acceleration pulse, and the like.

In various embodiments, the cycling of ion generating pulses can be selected so that arrival times of ion species from the one or the multiple defined ranges at the ion receiver deviate from one another and do not correspond over a large number of ion generating pulses and acceleration pulses, in particular do not overlap. The following relationship illustrates the condition for the duration between two successive ion generating pulses, which is to be shorter than the longest time-of-flight, and ensures at the same time that ion signals of each two ion species of different mass to charge ratios from successive ion generating pulses are not superimposed or overlapping in a time-of-flight transient:

$$\frac{{Δ}_{TOF , {m}_{2} , {m}_{1}}}{{t}_{prrp}} ∉ ℤ .$$

In this case, m₁ stands for a first mass (with the understanding that the charge number is uniform, in particular c=1 as in MALDI, wherein the mass then corresponds to the mass to charge ratio), m₂ stands for a second mass deviating from m₁, Δ_{TOF,m}_{₂}_{,m}_{₁} stands for the time-of-flight difference or difference of the arrival time at the ion receiver of ion species of the masses m₂ and m₁, Z stands for the set of whole numbers, and tₚᵣᵣₚ stands for the duration between two ion generating pulses (prrp: pulse repetition rate period).

It follows from the condition specified above that

$$\frac{{Δ}_{TOF , {m}_{2} , {m}_{1}}}{{t}_{prrp}} ∈ ℝ ,$$

thus a real number which avoids an overlap. This can be achieved in that a period duration is selected which is somewhat longer than the time-of-flight difference between the two ion species (and is shorter than the longest time-of-flight). If there should be more than two molecular species of interest in one or multiple defined m/z ranges, the selection of a period duration which is somewhat longer than the time-of-flight difference between the two molecular species having the greatest mass difference and therefore time-of-flight difference would result in a real number and meet the condition. Of course, it is possible to select period durations which are shorter than the time-of-flight difference or difference of the arrival time at the ion receiver between two ion species (or a large number of ion species). However, it is then to be ensured that the condition results in a real number for all observed mass differences. It is likewise to be considered that this condition is based on an ideal observation having infinitely narrow ion signals in the time-of-flight transients. In practice, ion signals have a finite width, so that the user has to weigh which degree of overlap they wish to permit at the flank of an ion signal. Preferably, a setting is selected which ensures that the ion signals are separated by baselines. In the time-of-flight transient of an axial time-of-flight mass analyser having single reflection, the full width at half maximum of an ion signal can be, for example, approximately 1-2 ns.

Taking into consideration decay processes of ion species of interest from the one or the multiple defined m/z ranges in the selection of a pulse repetition period duration can be indicated, which avoids catching up, overtaking, or overlapping of ion signals in the one or the multiple time-of-flight transients. The knowledge of possible decay processes of the ion species of interest is helpful in this case. The in-source decay (ISD) is simple to detect insofar as the decay takes place before the generated ion species, including any product species, are accelerated out of the ion generating unit. The knowledge of the decay products of an ion species of interest, more precisely their mass and therefore time-of-flight, enables the consideration in the calculation of time-of-flight differences. In the case of post-source decay (PSD), the situation is to be observed in a more differentiated manner, since the time-of-flight behavior of the decay product depends on the time of the decay. If an ion species of interest decays after exiting from the ion generating unit and after passing any potential-providing elements along the flight route, nothing changes in the observation, because the decay products do have a mass deviating from the precursor species but do not have a time-of-flight deviating therefrom, therefore arrive simultaneously with the precursor species at the ion receiver. In contrast, if an ion species of interest decays after exiting from the ion generating unit but before entering, for example, a reflector along the flight route, the times-of-flight of the precursor species and the product species differ from one another due to the different kinetic energies after the decay and the different penetration depths into the reflector thus caused. If known decay products of an ion species of interest are likewise of interest, it is advisable to take into consideration their mass and time-of-flight when defining m/z ranges and selecting pulse repetition period durations.

In various embodiments, the cycling of ion generating pulses can be selected so that the duration between two successive ion generating pulses is greater than the time-of-flight which corresponds to the greatest m/z upper limit. This procedure is preferably connected to an operating mode of the ion selector which generally sorts out ion species from detection at the ion receiver which lie outside the one or the multiple defined m/z ranges, for example, in the direction of lower mass to charge ratios, corresponding to shorter second fly through times, and/or higher mass to charge ratios, corresponding to longer second fly through times. To take the switching time of the ion selector into consideration, the cycling of ion generating pulses can be selected so that the duration between two successive ion generating pulses corresponds to the time-of-flight of the greatest m/z upper limit plus the switching time or a multiple of the switching time of the ion selector, in order to enable a setting of the ion selector, according to which ion species having mass to charge ratios which lie below an m/z lower limit of the defined range, for example, MALDI matrix substance ions, are prevented from flying further to the ion receiver.

In various embodiments, the cycling of ion generating pulses can be selected in an interval from a group comprising or consisting of: >10 kHz-100 kHz, >10 kHz-50 kHz, >10 kHz-20 kHz, 20 kHz-100 kHz, 20 kHz-50 kHz, 50 kHz-100 kHz. In particular, a cycling can be selected which is greater than or equal to 11 kHz, greater than or equal to 12 kHz, greater than or equal to 13 kHz, greater than or equal to 14 kHz, greater than or equal to 15 kHz, greater than or equal to 16 kHz, greater than or equal to 17 kHz, greater than or equal to 18 kHz, greater than or equal to 19 kHz, greater than or equal to 20 kHz, preferably in each case with an upper limit of 20 kHz, 50 kHz, or 100 kHz. The cycling can be mono-frequency, in the sense that the duration between two successive ion generating pulses remains constant over many ion generating pulses and does not change.

In various embodiments, the ion selector can be designed as a (i) Bradbury-Nielsen gate, (ii) a grating supplied with radio-frequency voltages, as is described, for example, in patent publication U.S. Pat. No. 5,572,035 A, to which reference is hereby expressly made by citation, or (iii) a deflection capacitor, which lets ion species pass when it is deenergized and deflects ion species from the intended flight route when voltage is received. Further technologies of ion selectors or ion gates are known to a person skilled in the art, which can be used in the scope of the present disclosure but are not listed or explained in detail for the sake of clarity.

In various embodiments, a tissue section or a cell culture can be used as the sample material. A tissue section can be cut from a frozen block or a FFPE-prepared block (FFPE=Formalin-fixed, Paraffin-embedded), for example, using microtomy. A cell culture can comprise cells which are, for example, of human or animal origin. In particular, a cell culture can grow directly on the sample carrier, for example, by in situ cultivation, or can be deposited there. The cell culture can contain tissue cells. The cells of a cell culture can be taxonomically classified as prokaryotes, for example, cells of a bacteria or archaea species, or eukaryotes, e.g., human, animal, plant, fungal, or algae cells.

In various embodiments, a distribution of molecular species, the mass to charge ratio of which lies in the one or the multiple defined ranges, can be determined across the sample material. A number of molecular species is preferred which is selected from a group comprising or consisting of: 1, 2, 3, 4, 5, 10, 15, 20, 25, 30, 35, 40, 45, 50, 60, 70, 80, 90, 100, or any other arbitrary natural number greater than or equal to 1. The preparation of a molecule distribution map in particular permits the locating of occurrence and frequency of molecular species of interest over the sample material.

A tissue section can comprise, for example, various tissue types of different molecular signatures, which can be detected; consider muscle and tendon tissue or various cell types in the brain, for example, grey matter and white matter.

In various embodiments, the sample material can be prepared on the sample carrier for matrix-assisted ionization, in particular matrix-assisted laser desorption and ionization, MALDI. The sample material can be prepared using a matrix substance capable of light absorption. Depending on the requirements, MALDI methods in incident light (in reflection) or in transmitted light (in transmission) come into consideration for the ion generating pulse. The MALDI method requires a specific sample preparation using a light-absorbing matrix substance, e.g., sinapinic acid, 2,5-dihydroxy benzoic acid, α-cyano-4-hydroxy cinnamic acid, or 2,5-dihydroxy acetophenone, which all absorb strongly in the ultraviolet spectral range. For example, laser light of a nitrogen laser at approximately 337 nm wavelength or a frequency-tripled solid-state Nd:YAG laser at approximately 355 nm is suitable for an ion generating pulse. The energy of the ion generating pulse is preferably in the range of 1-10,000 nanojoules, wherein the lower limit is applicable in particular in the case of small laser foci on the sample material, as are settable, for example, in transmission MALDI or MALDI in transmitted light. Primary ion generating pulses can be supplemented by a post-ionization modality in order to increase the ionization yield and improve the detection sensitivity, as presented, for example, in the study by Jens Soltwisch et al. (Science 2015, 348 (6231), 211-215), to which reference is hereby expressly made by citation.

In various embodiments, the (axial) time-of-flight mass analysis can operate using a nonlinear, for example, reflector-turned, flight route. A reflector on the flight route which comprises, for example, a stack of aperture electrodes arranged one behind another, to which different electrical potentials are applied, can reduce the spread of the times-of-flight of ion species having the same mass to charge ratio m/z, which is caused by the spread of the kinetic energy of this ion species during the acceleration out of the ion generating unit. Flight routes having single reflection are particularly preferred. Linear or straight-line flight routes are also conceivable and compatible with the present disclosure. A linear flight route ensures the greatest possible sensitivity of the ion detection, since ion species or molecules derived therefrom can hardly be lost in flight.

In various embodiments, the one or the multiple defined ranges can each comprise an m/z lower limit and an m/z upper limit, which are not farther apart from one another than a value selected from a group comprising or consisting of: Δm/z 2000, 1500, 1000, 900, 800, 700, 600, 500, 400, 300, 200, 100, 50, 25, 10, 5, or any other arbitrary value between Δm/z 5 and Δm/z 2000. In an axial time-of-flight mass analyser, in particular having (single) reflector-turned flight route, m/z differences of, for example, 1 atomic mass unit can be resolved without problems, often even separated by baselines.

In various embodiments, the ion selector can be switched to blocking within a defined m/z range for one or multiple time spans, which corresponds or correspond to an interval of mass to charge ratios which is selected from a group comprising or consisting of (without consideration of any switching times): Δm/z 500, 400, 300, 200, 150, 100, 90, 80, 70, 60, 50, 40, 30, 20, 10, or any other arbitrary value between Δm/z 500 and Δm/z 10. In this way, interfering or background-generating ion species can be deliberately blanked out of the ion current by punctual actuation of the ion selector.

In various embodiments, one or multiple affinity probes can be hybridized with the sample material, wherein each affinity probe binds to a specific molecule in the sample material and comprises an ionizable affinity probe mass tag, which has a mass to charge ratio m/z that lies in a defined range. Preferably, an affinity probe comprises an affinity probe hull, which is detachably connected to the affinity probe mass tag. U.S. Pat. No. 7,569,392 B2 (Vanderbilt University), U.S. Pat. No. 8,221,972 B2 (Université des Science et Technologies de Lille), and U.S. Pat. No. 11,846,634 B2 (AmberGen, Inc.) are cited here by way of example with respect to affinity probes and their use in imaging mass analysis of tissue sections in particular, to which reference is expressly hereby made by citation.

In various embodiments, energy can be applied to the sample material, for example, electromagnetic waves, to detach affinity probe mass tags. Preferably, energy application and ion generating pulses can be executed separately from one another in time. Mass tags or mass labels can be connected to an affinity probe hull via a photo-cleavable bond. The affinity probe hull specifically binds with a molecule on the sample material, which is only accessible to detection using time-of-flight mass analysis with difficulty, for example, because it does not have good ion generating properties and/or has unfavorable flight behavior. Very large and heavy proteins are mentioned as an example of such molecules which are difficult to detect. The affinity probe mass tag functions in this embodiment as a proxy for the detection of the molecule actually of interest on the sample material. Detaching the affinity probe mass tag can take place before the actual ion generation but also in the course of the ion generation itself. The chronological separation of detaching and ion generating enables conditions to be selected more freely for the energy application, since less consideration has to be taken of the conditions of the ion generation, whereas detaching in the course of the ion generation can result in a time advantage in that it links the two steps with one another, wherein the requirements for the detaching and ion generation are to be reconciled with one another, however.

In various embodiments, reporter peptides or reporter polypeptides can be used as affinity probe mass tags. Peptides are chains of amino acids and can be compiled and synthesized in a large number of arrangements. Peptides fundamentally have good ion generating properties and favorable flight behavior and are therefore particularly suitable for use as a mass tag/label molecule (mass tag). According to the Gold Book of the International Union of Pure and Applied Chemistry (IU PAC), a polypeptide is characterized by a chain length of 10 or more amino acids.

In various embodiments, one or multiple affinity probes can be hybridized with proteins on the sample material. Proteins represent useful and informative target molecules for various reasons, in particular with respect to function and structure, since they play an important role in the lifecycle of a biological cell. Furthermore, pathogenic changes can often be detected on them, so that they can be useful in explaining disease mechanisms. In this context, protein analyses are therefore frequently used in drug development, since the effect and action of a drug candidate on the proteins of a test subject have to be explained, for example, resistance or susceptibility of a substrate, such as a peptide, to an enzyme.

In various embodiments, the one or the multiple defined ranges can be selected so that they contain a large number of molecules from a group of starting materials/educts and products of a chemical, biological, or chemical-biological reaction and the sample material comprises an array of isolated preparations at different times of a reaction of the same starting materials/educts. One example of such a method is the sampling over time of the conversion of a substrate into one or multiple degradation products by reaction of the substrate with a reagent. The substrate can be, for example, an antimicrobial substance such as a β-lactam antibiotic, which is brought together with an enzyme, such as a β-lactamase, as a reagent and can be degraded in this case. Patent publications WO 2011/154517 A1 and WO 2012/023845 A1 are cited for more detail on this example, to which reference is hereby expressly made by citation.

One possible embodiment can run so that a reaction is initiated in a reaction vessel, wherein the reactants are present in a large quantity, and this reaction vessel is sampled at different times after the merging, wherein the sequentially taken fluid aliquots are then applied to different points of a sample carrier and possibly prepared, for example, with addition of a MALDI matrix substance. Alternatively, it is possible to have a reaction to be monitored run directly on a sample carrier simultaneously in a field of micro droplets as replicates under identical conditions and to stop the reaction in individual micro droplets at different times, for example, by fluid withdrawal or another intervention. The field of reaction phases chronologically coded in this way is directly available, possibly after suitable preparation, for a mass-analytic study.

According to another aspect, the disclosure relates to imaging mass analysis of sample material carried out using a method as described above.

According to still another aspect, the present disclosure relates to a device for analysing sample material applied to a sample carrier, comprising:—an (axial) time-of-flight mass analyser, which comprises an ion generating unit having a mount for the sample carrier, an ion receiver, a flight route between ion generating unit and ion receiver, which co-determines a longest time-of-flight, an ion selector along the flight route, and a clock generator for repeatedly triggering an ion generating pulse locally at the sample carrier and a subsequent pulse for accelerating ion species directly out of the ion generating unit onto the flight route; and—a guidance and/or control system, which communicates with the ion generating unit, the ion receiver, the ion selector, and the clock generator, and which has an input interface via which data are transmitted to the guidance and/or control system to define one or multiple ranges of mass to charge ratios m/z each having an m/z upper limit, which corresponds to a time-of-flight that is shorter than the longest time-of-flight, and which is furthermore arranged and designed to actuate the clock generator such that a cycling for triggering ion generating pulses onto the flight route is selected so that a duration between two successive ion generating pulses is shorter than the longest time-of-flight and is longer than an acceleration time of ion species out of the ion generating unit, to actuate the ion selector such that for first fly through times, which correspond to one or multiple mass to charge ratios within the one or the multiple defined ranges, it lets ion species pass to the ion receiver and for second fly through times, which correspond to one or multiple mass to charge ratios outside the one or the multiple defined ranges, it prevents ion species from reaching the ion receiver, and to actuate the ion receivers such that ion currents beyond the longest time-of-flight are registered in one or multiple time-of-flight transients, which contains or contain ion signals of ion species from the one or the multiple defined ranges, wherein the guidance and/or control system ensures mass to charge ratios are assigned to the ion signals.

The input interface can be a graphic user interface, on which a user enters data via a keyboard about the one or the multiple ranges to be defined of mass to charge ratios. The input interface can also be an electronic data communication interface, via which data are exchanged with other electronic remote stations. Details on the one or the multiple ranges to be defined can be retrieved there from a database, for example.

The guidance and/or control system can be a computer, a processor, or another data processing and control unit which is capable of receiving, processing, and passing on data and outputting control commands derived therefrom. The guidance system can be organized in a centralized or decentralized manner. Organized in a decentralized manner can mean that different assemblies of the device, which are partially spatially separated from one another, are equipped with circuits or processing units (for example, digital signal processors), which communicate and exchange data with respective other assemblies.

A person skilled in the art understands that further advantageous embodiments of the device according to the disclosure result by reference to the statements on the method according to the disclosure, which can be applied without problems to the device according to the disclosure.

### BRIEF DESCRIPTION OF THE DRAWINGS

Reference is made to the following figures for better comprehension of the invention. The elements in the figures are not necessarily shown to scale, but rather are primarily intended to illustrate the principles of the invention (largely schematically). In the figures, elements corresponding to one another are identified by the same reference signs in the various views.

FIG. 1 schematically shows an axial MALDI time-of-flight mass analyser, using which principles of the present disclosure can be implemented.

FIG. 2 illustrates by way of example the relationship between time-of-flight and mass to charge ratio m/z for an axial time-of-flight mass analyser having single reflection as schematically shown in FIG. 1.

FIG. 3 illustrates by way of example the relationship between fly through time on the ion selector and mass to charge ratio m/z for an arrangement of the selector as schematically shown in FIG. 1.

FIG. 4A illustrates a time-of-flight scheme for a modified pulse and wait approach with focus on mass to charge ratios of interest from a defined range in comparison to a conventional pulse and wait approach.

FIG. 4B schematically shows a time axis having two separate time-of-flight transients recorded in succession according to the conventional pulse and wait approach.

FIG. 5A by way of example shows a switching scheme for an ion selector according to the modified pulse and wait approach illustrated in FIG. 4A.

FIG. 5B schematically shows a time axis having a time-of-flight transient, which contains ion signals from multiple pulse sequences, according to the modified pulse and wait approach explained in the disclosure.

FIG. 6 schematically shows an experimental design having two defined ranges of mass to charge ratios which can contain ion species of interest.

### DETAILED DESCRIPTION

While the invention was represented and explained on the basis of a number of embodiments, a person skilled in the art in the field will recognize that various changes in form and detail can be performed thereon without deviating from the scope of the technical teaching defined in the appended claims.

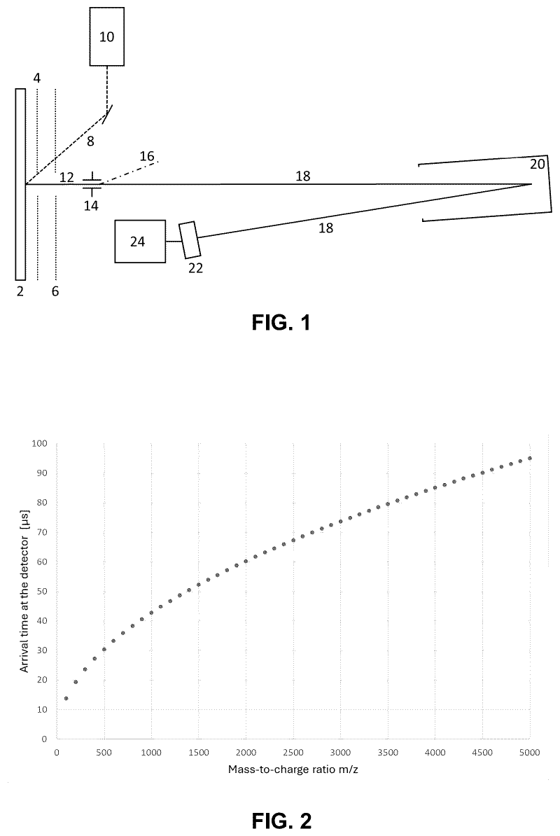

FIG. 1 schematically shows an axial MALDI time-of-flight mass analyser, using which principles of the present disclosure can be implemented. Sample material, for example, in the form of a tissue section, is located on the sample carrier 2 opposite to the acceleration electrodes 4 and 6, and the sample material can be guided by a relative movement of the sample carrier 2 into the pattern of a spot of a beam-profiled laser light pulse 8 of the laser system 10 and ionized there. The ion species generated in a pulsed manner are accelerated by the application of attracting potentials to the electrodes 4 and 6 to form an ion beam 12, which has to pass an ion selector 14, so that its ion species can be deflected and rejected as a beam 16 at selected times. The remaining ion beam 18, which contains the ion species of interest that are let through, is then reflected by the reflector 20 onto the secondary electron multiplier 22, the output current of which is supplied to a transient recorder 24 and converted therein into a series of digital measured values and stored.

One essential property of such axial time-of-flight mass analysers is that the sample material which is removed from the sample carrier and ionized is sent in its entirety onto the flight route by an acceleration pulse. In contrast thereto, it is possible in a time-of-flight mass analyser with orthogonal acceleration to filter or sort the ion species using further methods on the path from the ion source to the pulser, thus before the orthogonal pulsing out of ion species onto the flight route. Filtering can be achieved, for example, using a quadrupole mass filter, which is arranged in the ion path between ion source and pulser and permits stable paths for ion species of specific mass to charge ratios depending on the parameters of the applied combination of DC voltage and radio-frequency voltage, whereas ion species having mass to charge ratios deviating therefrom are excited upon passage through the mass filter, do not follow a stable path, and are laterally rejected, whether by escaping through the gaps between the pole electrodes or by striking the electrically conductive pole electrodes and the resulting neutralization. Sorting can be achieved, for example, by ion mobility separation in the gas phase. During the passage through an ion mobility separating cell, which is arranged between the ion source and the pulser, ion species are held back by different strengths depending on their active cross-section to charge ratio and accordingly leave the separating cell at different times. This procedure is accompanied by expansion over time of the originally present ion current, which ensures that principles of interleaving and multiplexing in conjunction with time-of-flight mass analysers, which operate using orthogonal acceleration of ion species onto the flight route, are simpler to carry out by suitable measures.

FIG. 2 illustrates by way of example the relationship between time-of-flight of ion species, i.e. their arrival time at the ion receiver, and mass to charge ratio m/z for an axial time-of-flight mass analyser using single reflection, as is schematically shown in FIG. 1. The longest time-of-flight is about 100 μs here, which corresponds to a mass to charge ratio of approximately m/z 5000. The electrical potential difference applied for the acceleration pulse, by which ion species are accelerated out of the ion generating unit onto the flight route, is approximately 2-3 kV and, in consideration of an additional static potential gradient between sample carrier and ion receiver, results in a total energy equivalent of approximately 20 kV.

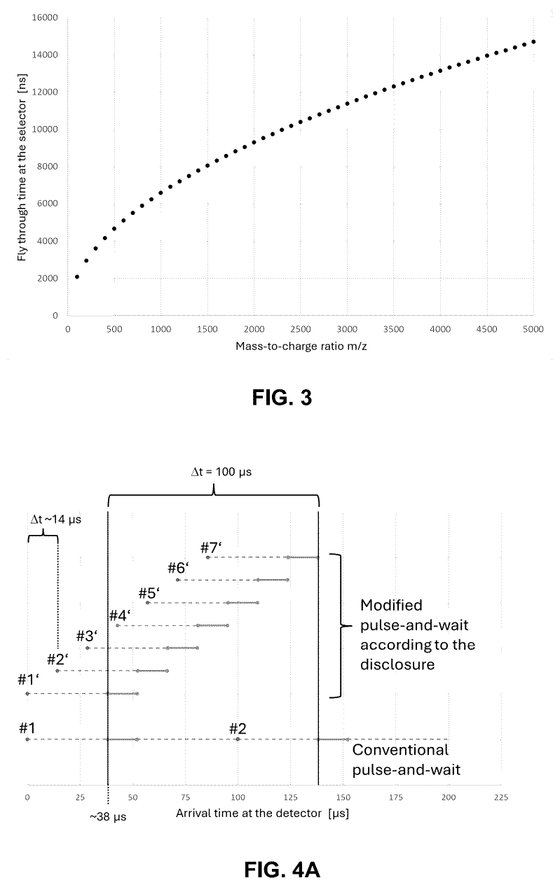

FIG. 3 illustrates by way of example the relationship between fly through time at the location of the ion selector and mass to charge ratio m/z for a structure in which the ion selector is positioned along the flight route at approximately 40 cm distance from the ion generating unit. The switching time (transmitting⇔blocking) of the ion selector can be 20 ns. In this arrangement, this time span corresponds to mass to charge ratio intervals of approximately Δm/z 5.5 and Δm/z 7.5 in the case of fly through times, which correspond to mass to charge ratios of approximately m/z 800 or m/z 1500, respectively. That is to say, in these short intervals, the operating modes of transmitting and blocking are restricted or incompletely active.

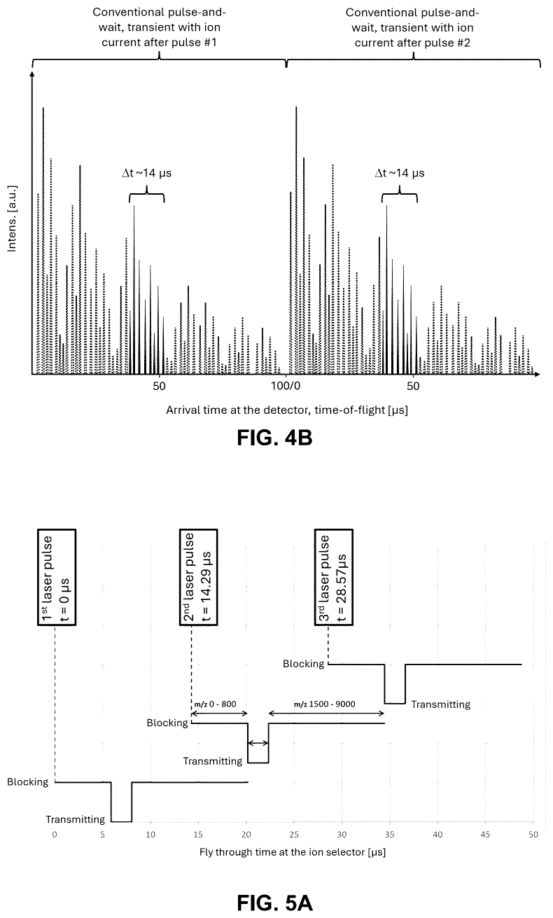

FIG. 4A illustrates a partial aspect of a first exemplary embodiment of the teaching according to the disclosure. The starting point is the determination that in an examination of sample material, only molecules having a specific mass to charge ratio are of predominant interest, whereas the remaining molecular species of the sample material are of subordinate interest and can be neglected. This example relates to molecules of interest which have mass to charge ratios in a range between m/z 800 and m/z 1500. The examination of a tissue section on the basis of proxy molecules can be used as an example of such an experimental design, for example, affinity probes which comprise detachable mass tags having good ion generating properties and good flight properties for a time-of-flight mass analyser. The affinity probes are applied to the sample material and hybridize with the corresponding target molecules, for example, proteins, where they are present. The mass tags of the affinity probes can be embodied, for example, as reporter polypeptides, the compositions of which from amino acids can be designed in such a variety of ways that affinity probes having a variety of mass tags resolvable with respect to time-of-flight can be produced for different target molecules of characteristic masses. With time-of-flight resolution capacity typical for time-of-flight mass analysers, a variety of such reporter polypeptides can be placed so they are resolvable with respect to time-of-flight in the defined range from m/z 800 to m/z 1500 (Δm/z 700). With a mean interval of the mass tags from one another of approximately Δm/z=7, up to 100 mass tags can be housed in the defined range. Such an interval along the m/z axis can be unified substantially without problems with typical switching times of an ion selector along the flight route.

Ion signals in the ranges of the mass to charge ratio up to m/z 800 (m/z lower limit) and above m/z 1500 (m/z upper limit) thus represent unused data ballast in a transient in this example. In such an experiment design, the property of a time-of-flight mass analysis of being able to map ion species of a very broad m/z range in the same transient has proven not to be particularly effective. The reason is illustrated in the lower section of FIG. 4A. To register the greatest possible width of the detectable m/z range and to obtain time-of-flight transients having an unambiguous assignment of time-of-flight to mass to charge ratio, which is typically desired in order to facilitate or even enable the further processing and evaluation of the obtained data, the prior art works with an approach which is referred to as pulse and wait. This procedure includes determining the longest time-of-flight of the time-of-flight mass analyser in its specific structural design, for example, including the specific length of the flight route, the presence of one or multiple reflectors along the flight route, etc., and using the specifically selected operating mode, for example, the selected potential gradient between sample carrier and ion receiver, etc., and selecting a duration between two ion generating pulses such that in any case it is not shorter than the determined longest time-of-flight, since it is thus ensured that all ion species which arise in a sequence of ion generating pulse and subsequent acceleration pulse have reached the ion receiver before further ion species from a later sequence of such pulses are sent onto the flight route. The signals of ion species of a pulse sequence are then typically stored separately in individual transients for further processing and subsequently further processed and evaluated.

In the lower section of FIG. 4A, this pulse and wait approach is shown using an ion generating pulse cycling of 10 kHz, which corresponds to a period duration between two ion generating pulses of 100 μs. The ion generating pulses are represented and numbered as points along the timeline from left to right. In the example shown, lower and upper limit of the mass to charge ratio of the defined range, wherein the section in between along the timeline is embodied as a thick line, correspond to the arrival times at the ion receiver of approximately 38 μs (m/z 800) and approximately 52 μs (m/z 1500).

FIG. 4B schematically illustrates a time-of-flight transient scheme according to the conventional pulse and wait approach. The ion current which results from a sequence of ion generating pulse and acceleration pulse is registered in a single time-of-flight transient and recorded separately, the length of which corresponds to the pulse repetition period duration (Δt=100 μs). The ion species actually of interest from a defined range are highlighted. No (or almost no) interference takes place between ion species which originate from successive pulse sequences. In order that this condition can be implemented, the cycling of the ion generation has to be restricted by the pulse repetition period duration; in the illustrated example, to 10 kHz.

One essential goal of the present disclosure is to register the ion species actually of interest for an experiment from one or multiple restricted ranges of mass to charge ratios with a higher recording rate. For this purpose, the cycling of the ion generation can be increased. More extensive prior consideration before the detailed description is rewarding.

The arrival times of ion species at the ion receiver (time-of-flight) result as:

$${t}_{arrival , {m}_{x}} = {t}_{TOF , {m}_{x}} + ( {n}_{{m}_{x}} - 1 ) \times {t}_{prrp} where {n}_{{m}_{x}} = 1 , 2 , 3 , … ∈ ℕ$$

t_{TOF} is the time-of-flight including delay time of the acceleration of an ion species from the generating unit to the ion receiver in microseconds. “prrp” stands for pulse repetition rate period, therefore tₚᵣᵣₚ identifies the period duration between two ion generating pulses in microseconds. “x” is the numeric index for the ion species of different masses, for example, peptide reporter ions of affinity probes. “n” is the numeric index of the ion generating pulses.

Two different ion species m₁ and m₂ are observed:

$${t}_{arrival , {m}_{1}} = {t}_{TOF , {m}_{1}} + ( {n}_{{m}_{1}} - 1 ) \times {t}_{prrp} \\ and$$

$${t}_{arrival , {m}_{2}} = {t}_{TOF , {m}_{2}} + ( {n}_{{m}_{2}} - 1 ) \times {t}_{prrp}$$

The following applies for the condition of equal arrival time at the ion receiver:

$${t}_{arrival , {m}_{1}} = {t}_{arrival , {m}_{2}} \\ {t}_{TOF , {m}_{1}} + ( {n}_{{m}_{1}} - 1 ) \times {t}_{prrp} = {t}_{TOF , {m}_{2}} + ( {n}_{{m}_{2}} - 1 ) \times {t}_{prrp} \\ \frac{{t}_{TOF , {m}_{1}}}{{t}_{prrp}} + {n}_{{m}_{1}} - 1 = \frac{{t}_{TOF , {m}_{2}}}{{t}_{prrp}} + {n}_{{m}_{2}} - 1 \\ {n}_{{m}_{1}} = \frac{{t}_{TOF , {m}_{2}} - {t}_{TOF , {m}_{1}}}{{t}_{prrp}} + {n}_{{m}_{2}} \\ {n}_{{m}_{1}} = \frac{{Δ}_{TOF , {m}_{2} , {m}_{1}}}{{t}_{prrp}} + {n}_{{m}_{2}}$$

Since n always has to be a natural number, the following condition also applies for corresponding arrival times of the various masses (with equal charge number, for example, c=1):

$$\frac{{Δ}_{TOF , {m}_{2} , {m}_{1}}}{{t}_{prrp}} ∈ ℕ$$

The set of whole numbers [symbol] can also be taken into consideration if one does not wish to consider the sequence of the times-of-flight of the individual masses in the subtraction. This condition is only met if the time-of-flight difference can be divided by the pulse repetition period duration without remainder. Vice versa, it follows therefrom that corresponding arrival times of ion species of two different masses can be avoided if the fraction does not result in a natural number, but rather is a real number, for example.

Obviously, a real number always results if the pulse repetition period duration is greater than the time-of-flight difference of the observed ion species of interest, wherein of course a pulse repetition period duration is not selected in the scope of the present disclosure which corresponds to the longest time-of-flight or even beyond this, because otherwise the conventional pulse and wait approach would be carried out again, according to which the condition for catching up or overtaking is never met. In the example above, the times-of-flight of ion species with m/z 800 and those with m/z 1500 are approximately 14 μs apart from one another, see FIG. 2. Even if times-of-flight which do not correspond to these lower and upper limits, but rather lie within the defined range between these two range boundaries, are selected, the condition of the real number would be met in any case. For the example, this means that a pulse repetition period duration of 14 μs, plus a small safety time span, can be selected without catching up or even overtaking effects occurring on the flight from the ion generating unit to the ion receiver for ion species within the defined m/z range, a type of modified pulse and wait approach. This embodiment is executed in the upper section of FIG. 4A. In comparison to the conventional pulse and wait approach, this means an increase of the cycling by a factor of 7, thus 70 kHz instead of 10 kHz before, with corresponding acceleration of the data registration.

With such an increase of the cycling of the ion generating pulses, it is to be noted that catching up and also overtaking effects of ion species from successive sequences of ion generating and acceleration pulses can certainly occur, which do not have a mass to charge ratio within the defined range, in this example thus m/z 800-1500, for example, ion species of a MALDI matrix substance at the lower end, which catch up with slowly flying ion species of interest of a following pulse sequence, and ion species of more complex, higher-mass polymers at the upper end of the m/z scale, which are caught up to by rapidly flying ion species of interest of a following pulse sequence. These can interfere with the detection of the ion species actually of interest from the defined range, can form background in the one or the multiple time-of-flight transients, and can make the assignment of mass to charge ratios to the times-of-flight, at which signals in the one or the multiple transients are observed, more difficult or even impossible.

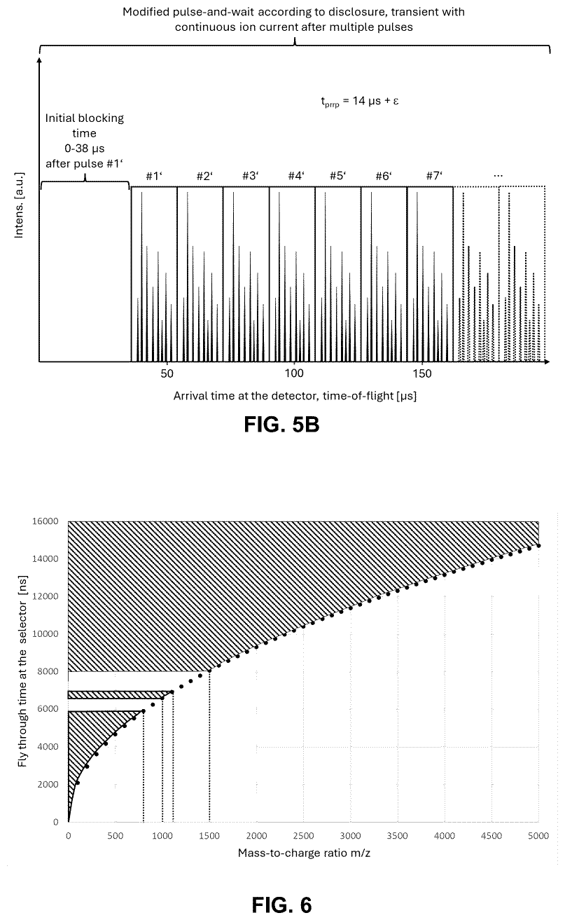

The operation of the ion selector along the flight route comes into play here. The ion selector enables a large part of the ion species, the mass to charge ratio of which does not fall in the one or the multiple defined m/z ranges, to be sorted out and discarded. For this purpose, the ion selector can be switched to blocking simultaneously with the triggering of the acceleration pulse, until the time has passed for the ion species of interest having the lowest mass to charge ratio compatible with the defined range, therefore which corresponds to its m/z lower limit, for example, m/z 800, to prepare to pass the ion selector. In consideration of the switching time of the ion selector of, for example, 20 ns, which at m/z 800 corresponds to an m/z interval of approximately Δm/z 5.5, this selector is switched to transmit (for example, for a fly through time which corresponds to the m/z lower limit minus the switching time of the selector, thus here m/z 800−m/z 5.5=m/z 794.5, in order to ensure that the flight of the ion species is not impaired by switching effects), so that the first ion species of interest can pass through the ion selector and moves undisturbed toward the ion receiver on the flight route. This switching scheme is illustrated in FIG. 5A. After the ion species of interest having the greatest mass to charge ratio compatible with the defined range, therefore corresponding to its m/z upper limit, for example, m/z 1500, has safely passed the ion selector, the ion selector can be switched back to blocking, so that ion species having mass to charge ratios outside the one or the multiple defined m/z ranges are again sorted out and discarded. This blocking state of the ion selector can be maintained until the ion species which again corresponds to the m/z lower limit of the defined range and originates from the following sequence of ion generating pulse and acceleration pulse prepares to pass the ion selector, etc.

In the switching scheme shown in FIG. 5A, the open phases of the ion selector last approximately 2.1 μs, which corresponds to a mass to charge ratio interval of m/z 1500−m/z 800=Δm/z 700, which can alternate with blocking durations of approximately 12 μs length, which in turn results from the difference of the selected pulse repetition period duration (14 μs) and the fly through time of the ion species which corresponds to the m/z upper limit (m/z 1500, ˜8 μs plus the fly through time of the ion species which corresponds to the m/z lower limit, m/z 800, ˜6 μs). The blocking of the ion selector from approximately 8 μs for a time span of approximately 12 μs ensures that ion species having mass to charge ratios of greater than m/z 1500 to m/z˜9000 are removed from the flight route and do not reach the ion receiver. A significant reduction of the background of ion signals not of interest in the one or the multiple time-of-flight transients and a perceptible relief of the ion receiver, the multiplication capacities of which are preserved, are achieved using this operating mode.

FIG. 5B schematically shows a time-of-flight transient which contains the ion species of the defined range over multiple pulse sequences if the ion selector is operated according to the disclosure and according to the above explanations of the exemplary embodiment. The pulse sequences #1′-#7′ correspond to those shown in the upper section of FIG. 4A. The transient recorder can additionally also acquire data from further pulse sequences ( . . . , shown by dashed lines in the figure), if its working memory permits it. However, even after the readout of the working memory, the next transient can be continued with the time index of the preceding transient. The data from different transients can then be merged by known postprocessing methods. Since the ion species from the defined range which are generated in different pulse sequences in the modified pulse and wait approach do not overlap, each ion signal from the transient can be unambiguously assigned to a mass to charge ratio even with steadily increasing time-of-flight. Very isolated background signals can emerge due to ion species in the transient which originate from m/z ranges outside the defined range, for example, of beyond m/z˜9000 if, as stated in the example, the ion selector is only switched to transmit during the fly through times, which correspond to ion species at the m/z lower limit and the m/z upper limit of the defined range. However, the proportion of the overall ion current in this high m/z range is so small according to experience that it does not predominate at least in relation to the pervasive chemical noise, but rather disappears in this omnipresent background.

The advantageous effects of the present disclosure can be illustrated on the basis of a numeric example:

A typical imaging mass-analytic examination of a tissue section detects, in a location-resolved manner, the molecular content from a plurality of picture elements or pixels measuring 20×20 μm², which cover the entire surface of the tissue section in a preferably continuous grid. If the tissue section is treated using a matrix substance for the MALDI method, typical diameters of the laser spot used for the removal and the ionization are approximately 10 μm. To sample the molecular content of a picture element in a sufficient quantity, typically a large number of laser shots are applied to the picture element, preferably hitting multiple points of the picture element, if the laser spot is significantly smaller than the pixel area, and the molecular information resulting in this case is merged after the detection at the ion receiver into a single summation transient or spectrum for the corresponding picture element. The number of the samples per picture element can be 140, for example. At a pulsed cycling of 10 kHz, a sampling rate of one tissue section picture element every 14 ms results from this information. With application of the modified pulse and wait approach having the restricted m/z range, as explained above, the sampling rate can be increased to one picture element every 2 ms. This observation is based on the established assumption that signal processing, for example, the actuation of the laser, and the deflection of the laser beam over a picture element area take place instantaneously during the emission of the 140 laser shots.

To assess the total utility for the measurement, the time also has to be taken into consideration which is required to align the laser beam onto the various image elements on the tissue section, which is typically performed by an electromechanical positioning element that carries the sample carrier on which the tissue section is deposited. If the time expenditure for the alignment change from picture element to picture element is assumed to be 36 ms, using the teaching according to the disclosure in the example explained, an acceleration of the measurement of 50 ms per picture element (14 ms+36 ms) in the conventional pulse and wait approach to 38 ms per picture element (2 ms+36 ms) in the modified pulse and wait approach according to the disclosure results, a shortening to about three fourths of the originally required time. In combination with further innovations, in particular those accelerating the electromechanical positioning, as described, for example, in patent publication DE 10 2021 114 934 B4 (corresponding to US 2022/0397551 A1), to which reference is hereby expressly made by citation, the overall utility of the present disclosure can come even more strongly to bear.

In a modification of the example explained with reference to FIGS. 4A, 5A, and 5B, the pulse repetition period duration can be shortened still further and therefore the cycling of the ion generation can be increased still further if catching up to and moderate overtaking of ion species of interest from the defined m/z range is permitted. This is described hereinafter.

It is assumed that the sample material is treated using a matrix substance for the MALDI method. UV-sensitive MALDI matrix substances are known for generating pronounced ion signals in low m/z ranges up to approximately m/z 800, partially in polymer and/or cluster form. Ion signals of a material which is used as a removal aid and charge carrier mediator, but otherwise hardly promises any additional informational value, can generate unnecessary data ballast which interferes with the actual ion signals of interest in the one or the multiple time-of-flight transients. It is therefore helpful for a mass-analytic examination to block the through flight of ion species from an m/z range beyond the m/z lower limit of the defined m/z range by corresponding actuation of the ion selector. This means that whenever the last ion species of interest from a sequence of ion generating pulse and acceleration pulse has passed the ion selector, the next ion generating pulse can be triggered. This permits the blocking of the ion selector until the fly through time of the ion species having a mass to charge ratio at the m/z lower limit and a subsequent short open phase of the ion selector in order to transmit the ion species of interest having mass to charge ratios from the one of the multiple defined m/z ranges. If the defined range, as already explained above, comprises m/z 800-1500, a pulse repetition period duration of approximately 8 (+ε) μs can be selected, wherein epsilon ε can be a safety time span in the nanosecond range. A shortening of the pulse repetition period duration from 100 μs in the conventional pulse and wait approach to now ˜8 μs corresponds to an acceleration of the data acquisition per picture element of approximately a factor of 12.

When considering this, it is to be noted that the pulse repetition period duration is less than the difference of the arrival time at the ion receiver of ion species which correspond to the m/z lower limit and the m/z upper limit (Δt˜14 μs). Therefore, ion signals of two molecules which have a time-of-flight difference of ˜8 μs would have mass to charge ratios from the defined range and would originate from successive pulse sequences in which one or the multiple time-of-flight transients overlap, which makes assigning mass to charge ratio to time-of-flight ion signal more difficult. It thus has to be ensured that the experiment is designed by suitable selection of the ion signals of interest so that an overlap of ion signals in the one or the multiple time-of-flight transients is avoided, for example, by using reporter polypeptides, the mass to charge ratios of which are in the defined m/z range and do not have a time-of-flight difference of 8 μs or an integer multiple thereof. In addition, properties of the ion signals can be taken into consideration in the assignment of times-of-flight to mass to charge ratios in order to increase the reliability, for example, an isotope pattern of the ion species of interest in the one or the multiple defined m/z ranges.

A further consequence of the increase of the cycling to ˜8 μs is that the blocking time following the open phase of the ion selector only lasts approximately 6 μs, in contrast to the ˜12 μs in the example explained on the basis of FIG. 4A and FIG. 5A, so that only ion species having mass to charge ratios of m/z 1500 to approximately m/z 4000 are sorted out by the ion selector from an ion population which originates from a sequence of ion generating pulse and acceleration pulse and do not reach the ion receiver. However, this is regularly acceptable, since experience teaches that the ion current in m/z ranges above m/z 4000 is still quite diluted, so that background resulting therefrom does not severely impair an evaluation of the recorded time-of-flight transients.

FIG. 6 illustrates a course of an experiment in which more than one contiguous range of mass to charge ratios is defined, and is based on the diagram in FIG. 3. In the example shown, two m/z ranges are defined by the user, a first from m/z 800 to m/z 1000 and a second from m/z 1100 to m/z 1500. The intermediate range of a width of Δm/z 100 between m/z 1000 and m/z 1100 is large enough that the ion selector can be switched to blocking in an intermediate phase. Accordingly, these blocking phases, in which ion species are sorted out and discarded, are highlighted by shading in the figure. Such an omission of a narrow m/z range from a larger m/z range, which fundamentally contains ion species of interest, can be indicated if very intensive ion signals not of interest are located there, for example, an ion signal which does not originate from the sample material as such, but rather was introduced into the sample material in a sample preparation step, for example, due to action of a reagent.

The invention has been described above with reference to various particular exemplary embodiments. However, it is apparent that diverse aspects or details of the described embodiments can be changed without deviating from the scope of the invention. Furthermore, the features and measures disclosed in conjunction with different embodiments can be combined arbitrarily provided this appears practical to a person skilled in the art. In addition, the above description only serves to illustrate the invention and not to restrict the scope of protection, which is exclusively defined by the appended claims in consideration of any existing equivalents.

1. A method for analysing sample material which is applied to a sample carrier, comprising:
providing a time-of-flight mass analyser, which comprises an ion generating unit having a mount for the sample carrier, an ion receiver, a flight route between the ion generating unit and the ion receiver, which co-determines a longest time-of-flight, an ion selector along the flight route, and a clock generator for repeatedly triggering an ion generating pulse locally at the sample carrier and a subsequent pulse for accelerating ion species directly out of the ion generating unit onto the flight route,
defining one or multiple ranges of mass to charge ratios m/z each having an m/z upper limit which corresponds to a time-of-flight that is shorter than said longest time-of-flight,
selecting a cycling of ion generating pulses such that a duration between two successive ion generating pulses is shorter than said longest time-of-flight and is longer than an acceleration time of ion species out of the ion generating unit,
analysing the sample material using the time-of-flight mass analyser and the selected cycling of ion generating pulses, wherein the ion selector is operated so that, for first fly through times, which correspond to one or multiple mass to charge ratios within the one or the multiple defined ranges, it lets ion species pass to the ion receiver, and for second fly through times, which correspond to one or multiple mass to charge ratios outside the one or the multiple defined ranges, it prevents ion species from reaching the ion receiver,
recording one or multiple time-of-flight transients at the ion receiver, which contains or contain ion signals of ion species from the one or the multiple defined ranges, and
assigning mass to charge ratios to the ion signals.

2. The method according to claim 1, wherein the cycling of ion generating pulses is selected so that arrival times of ion species from the one or the multiple defined ranges at the ion receiver deviate from one another over a large number of ion generating pulses and acceleration pulses and do not correspond or overlap.

3. The method according to claim 1, wherein the cycling of ion generating pulses is selected so that the duration between two successive ion generating pulses is greater than the time-of-flight which corresponds to a greatest m/z upper limit.

4. The method according to claim 1, wherein the cycling of ion generating pulses is selected in an interval from a group comprising or consisting of: >10 kHz-100 kHz, >10 kHz-50 kHz, >10 kHz-20 kHz, 20 kHz-100 kHz, 20 kHz-50 kHz, and 50 kHz-100 kHz.

5. The method according to claim 1, wherein the ion selector is designed as (i) a Bradbury-Nielsen gate, (ii) a grating supplied with radio-frequency voltages, or (iii) a deflection capacitor, which lets ion species pass when it is deenergized and deflects ion species from the intended flight route when voltage is received.

6. The method according to claim 1, wherein a tissue section or a cell culture is used as the sample material.

7. The method according to claim 1, wherein a distribution of molecules, the mass to charge ratio of which lies in the one or the multiple defined ranges, is determined over the sample material.

8. The method according to claim 1, wherein the sample material is prepared on the sample carrier for matrix-assisted ionization.

9. The method according to claim 1, wherein the time-of-flight mass analysis operates using a nonlinear flight route.

10. The method according to claim 1, wherein the one or the multiple defined ranges further comprises an m/z lower limit, and the m/z lower limit and the m/z upper limit are not farther apart from one another than a value selected from a group consisting of: Δm/z=2000, 1500, 1000, 900, 800, 700, 600, 500, 400, 300, 200, 100, 50, 25, 10, 5, or any arbitrary value between Δm/z=5 and Δm/z=2000.

11. The method according to claim 1, wherein one or multiple affinity probes are hybridized with the sample material, and each affinity probe binds to a specific molecule in the sample material and comprises an ionizable affinity probe mass tag, which has a mass to charge ratio m/z which is in a defined range.

12. The method according to claim 1, wherein the one or the multiple defined ranges are selected so that they contain a large number of molecules from a group of starting materials/educts and products of a chemical, biological, or chemical-biological reaction, and the sample material comprises an array of isolated preparations at different times of a reaction of said starting materials/educts.

13. The method according to claim 1, wherein analysing the sample material further comprises performing an imaging mass analysis of the sample material.

14. An apparatus for analysing sample material which is applied to a sample carrier, comprising:
a time-of-flight mass analyser, which comprises an ion generating unit having a mount for the sample carrier, an ion receiver, a flight route between the ion generating unit and the ion receiver, which co-determines a longest time-of-flight, an ion selector along the flight route, and a clock generator for repeatedly triggering an ion generating pulse locally at the sample carrier and a subsequent pulse for accelerating ion species directly out of the ion generating unit onto the flight route; and
a guidance and/or control system, which communicates with the ion generating unit, the ion receiver, the ion selector, and the clock generator, and which has an input interface via which data are transmitted to the guidance and/or control system to define one or multiple ranges of mass to charge ratios m/z each having an m/z upper limit, which corresponds to a time-of-flight that is shorter than said longest time-of-flight, and which is furthermore arranged and designed to actuate the clock generator such that a cycling for triggering ion generating pulses onto the flight route is selected so that a duration between two successive ion generating pulses is shorter than said longest time-of-flight and is longer than an acceleration time of ion species out of the ion generating unit, to actuate the ion selector such that for first fly through times, which correspond to one or multiple mass to charge ratios within the one or the multiple defined ranges, it lets ion species pass to the ion receiver and for second fly through times, which correspond to one or multiple mass to charge ratios outside the one or the multiple defined ranges, it prevents ion species from reaching the ion receiver, and to actuate the ion receiver such that ion currents beyond the longest time-of-flight are registered in one or multiple time-of-flight transients, which contains or contain ion signals of ion species from the one or the multiple defined ranges, wherein the guidance and/or control system ensures mass to charge ratios are assigned to the ion signals.
